(19) United States
(12) Patent Application Publication
(10) Pub. No.: US 2017/0171332 A1
(43) Pub. Date: Jun. 15, 2017

(54) Message pushing method, electronic device and non-transitory computer-readable storage medium

(71) Applicants: LE HOLDINGS (BEIJING) CO., LTD., Beijing (CN); LE SHI ZHI XIN ELECTRONIC TECHNOLOGY (TIANJIN) LIMITED, Beijing (CN)

(72) Inventors: Dehui HUANG, Beijing (CN); Yu Wang, Beijing (CN); Qi Zhang, Beijing (CN)

(21) Appl. No.: 15/242,254

(22) Filed: Aug. 19, 2016

Related U.S. Application Data
(63) Continuation of application No. PCT/CN2016/088729, filed on Jul. 5, 2016.

(30) Foreign Application Priority Data
Dec. 15, 2015 (CN) 2015109516458

(51) Int. Cl. H04L 29/08; H04L 12/58

(52) U.S. Cl. CPC H04L 67/26; H04L 51/24

(57) ABSTRACT

Disclosed are a message pushing method, an electronic device and a non-transitory computer-readable storage medium, an operation management background publishes and manages a resource, generates a notifying message related to the resource and transmits the notifying message to a message oriented middleware; the message oriented middleware obtains a resource ID from the notifying message, and based on the resource ID queries a follow center to obtain a list of users who follow the resource, and transmits the notifying message and the list of users who follow the resource to a message pushing center; the message pushing center, based on a user ID in the list of users, pushes the notifying message to a smart terminal by which the user ID is logged in and then marks the device ID of the smart terminal to avoid pushing repeatedly the notifying message to the same smart terminal.

### CROSS REFERENCE TO RELATED APPLICATIONS

The present application is a continuation of PCT application which has an application number of PCT/CN2016/088729 and was filed on Jul. 5, 2016. This application claims the priority to Chinese Patent Application No. 201510951645.8, entitled “MESSAGE PUSHING SYSTEM AND METHOD” and filed with the State Intellectual Property Office of People's Republic of China on Dec. 15, 2015, which is incorporated herein by reference in its entirety.

### TECHNICAL FIELD

The disclosure relates to the field of network technology, and particularly to a message pushing method, an electronic device and a non-transitory computer-readable storage medium.

### BACKGROUND

With the development of the Internet technology and the technology of converging three networks, a content provider can provide abundant content resources, including an audio and video entertainment resources, game resources, educational resources and so on. From a user's perspective, multiple applications installed on a same smart terminal may focus on a same resource. Where the content provider publishes an update for the resource, all of the multiple applications installed on the same smart terminal receive a notifying message as to the resource; repeated receiving the notifying message troubles the user, resulting in a poor user's experience. Therefore, how to avoid repeatedly transmitting the notifying message to the smart terminal is an urgent technical problem to be solved.

### SUMMARY

An objective of the present disclosure is to provide a technical solution, which can avoid repeatedly transmitting a notifying message to a smart terminal.

A message pushing method is provided according to a first aspect of an embodiment of the present disclosure, the message pushing method may include:

publishing and managing a resource, generating a notifying message related to the resource;

obtaining a resource ID from the notifying message related to the resource, querying based on the resource ID to obtain a list of users who follow the resource; and

based on a user ID in the list of users, pushing the notifying message related to the resource to a smart terminal which logs in to the user ID, and then marking the device ID of the smart terminal to avoid pushing repeatedly the notifying message to the same smart terminal.

Optionally, the message pushing method may further include:

receiving a follow/un-follow request for the resource transmitted from an application client of the smart terminal, where the follow/un-follow request contains the user ID, the device ID and a resource ID; setting a relation between the user ID and the resource ID in response to the follow/un-follow request and generating information as to change in follow state, where the information as to change in follow state contains the user ID and the resource ID; and transmitting the information as to change in follow state to each of the smart terminals bound to the user ID based on the device ID of each smart terminal.

According to the second aspect of embodiments of the present invention, it provides an electronic device, comprising: at least one processor; and a memory communicably connected with the said at least one processor; wherein the said memory stores instructions executable by the said at least one processor, wherein the said instructions are used to execute any one of the message pushing methods prescribed by the present application.

According to the third aspect of embodiments of the present invention, it provides a non-transitory computer-readable storage medium, wherein the said non-transitory computer-readable storage medium stores executable instructions, the said computer can execute the instructions to execute any one of the message pushing methods prescribed by the present application.

Exemplified embodiments of the present disclosure are described in detail below in conjunction with the drawings, so as to make other features and advantages of the present disclosure become clearer.

### BRIEF DESCRIPTION OF THE DRAWINGS

Embodiments of the present invention are to be further elaborated in detail with reference to the accompanying figures. It should be noted that, unless specifically stated otherwise, components and procedures of corresponding arrangements, numerical expressions and values disclosed do not limit the scope of the present invention.

FIG. 1 is a block diagram of a message pushing system according to some embodiments of the present disclosure;

FIG. 2 is block diagrams of a follow center and a smart terminal according to some embodiments of the present disclosure;

FIG. 3 is a schematic step diagram of a message pushing method according to some embodiments of the present disclosure;

FIG. 4 is a schematic diagram of a synchronous follow method according to some embodiments of the present disclosure; and

FIG. 5 illustrates the hardware structure of the device executing the message pushing method prescribed by the present invention.

### DETAILED DESCRIPTION

Various exemplary embodiments of the present disclosure are described in detail now with reference to the drawings. It should be noted that, unless otherwise stated, a relative arrangement of components and steps, a numerical expression and a value mentioned in the embodiments do not limit the scope of the present disclosure.

A description for at least one exemplary embodiment below is schematic only, and is never served as any limit for the disclosure and an application and usage thereof.

Technology, methods and devices known by those skilled in the art are not described in detail, however, the technology, the methods and the devices should be regarded as a part of the specification where appropriate.

In all the examples shown or discussed, any specific value is merely exemplary and is not used to limit. Therefore, other examples in the exemplary embodiment may have a different value.

It should be noted that, a similar reference sign and letter refer to a similar item in the drawings below, therefore, once an item is defined in a Figure, it is not necessary to discuss the item in subsequent Figures.

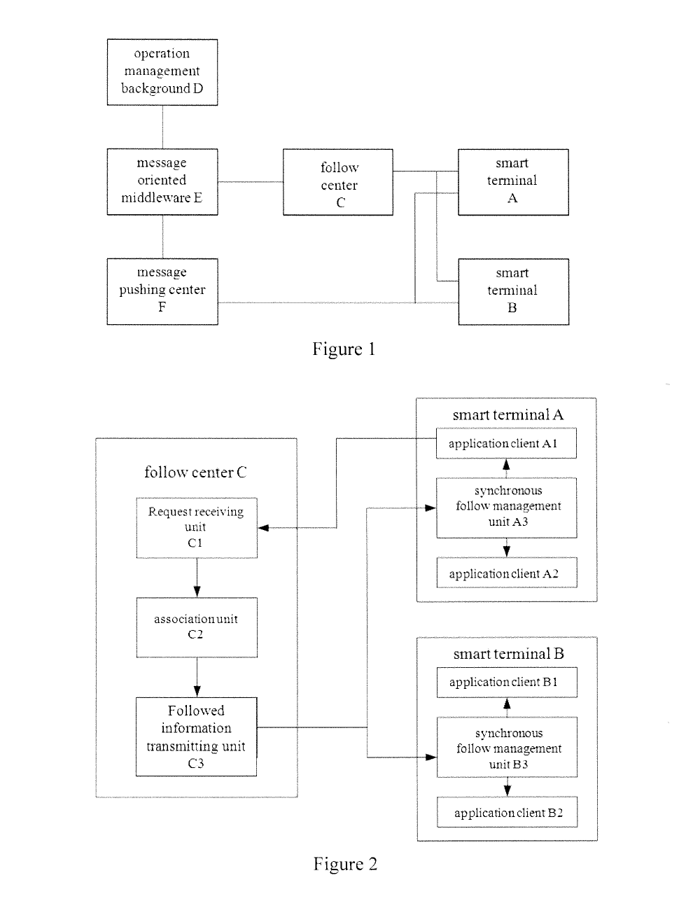

A message pushing system according to an embodiment of the present disclosure is illustrated with reference to FIG. 1 and FIG. 2.

The operation management background D is configured to publish and manage a resource, generate a notifying message related to the resource, and transmit the notifying message related to the resource to a message oriented middleware E. The resource in the present disclosure may be for example a celebrity, a movie, a player, a sport team, sports events, a show, a live broadcast and so on. The publishing and managing the resource in the present disclosure may be for example publishing a new episode of a TV play, changing a playing time and so on.

The message oriented middleware E is configured to obtain a resource ID from the notifying message related to the resource, and based on the resource ID query a follow center C to obtain a list of users who follow the resource, and transmit the notifying message related to the resource and the list of users who follow the resource to a message pushing center F. The message oriented middleware is a middleware which supports and guarantees synchronous/asynchronous transmitting and receiving a message between distributed applications.

The message pushing center F is configured to, based on a user ID in the list of users, push the notifying message related to the resource to a smart terminal A which logs in to the user ID and a smart terminal B which logs in to the user ID, and then mark a device ID of the smart terminal A and a device ID of the smart terminal B to avoid pushing repeatedly the same notifying message to the same smart terminal.

The smart terminal A includes an application client A1 and an application client A2. The application client A1 and the application client A2 simultaneously follow the resource. Since that the message pushing center F marks the device ID of the smart terminal A soon after pushing the notifying message, the same notifying message are not pushed to the smart terminal A twice where the application client A1 and the application client A2 follow the resource simultaneously.

The smart terminal B includes an application B1 and an application client B2. The application client B1 and the application client B2 follow the resource simultaneously. Since that the message pushing center F marks the device ID of the smart terminal B soon after pushing the notifying message, the same notifying message are not pushed to the smart terminal B twice where the application client B1 and the application client B2 follow the resource simultaneously.

A follow center and a smart terminal which supports synchronous follow according to an embodiment of the present disclosure are illustrated in FIG. 2.

The follow center C includes a request receiving unit C1, an association unit C2 and a followed information transmitting unit C3. The smart terminal A includes an application client A1, an application client A2 and a synchronous follow management unit A3. The smart terminal B includes an application client B1, an application client B2 and a synchronous follow management unit B3. The application client in the present disclosure may be for example a calendar, wallpaper, music, a video player and so on.

The application client A1 of the smart terminal A transmits a follow/un-follow request for a resource; the follow/un-follow request includes a user ID, a device ID and a resource ID. The follow request here may be a request to follow one or more resources, the un-follow request may be a request to un-follow one or more resources.

On the side of the follow center C, the request receiving unit C1 receives the follow/un-follow request transmitted by the application client A1. The association unit C2 sets a relation between the device ID and the resource ID in response to the follow/un-follow request, and generates information as to change in follow state carrying the user ID and the source ID. The followed information transmitting unit C3 transmits the information as to change in follow state to the synchronous follow management unit A3 of the smart terminal A based on the device ID of the smart terminal A bound to the user ID, and transmits the information as to change in follow state to the synchronous follow management unit B3 of the smart terminal B based on the device ID of the smart terminal B bound to the user ID. The association unit C2 is further configured to record the device ID to identify from which the follow/un-follow request comes.

According to actual situations, a request parameter of the follow/un-follow request may further include an SSO token of the user ID. Upon receiving the follow/un-follow request, the follow center C certifies whether the application client A1 of the smart terminal A logs in based on the SSO token in the SSO certification, and returns an error code “errno” to the application client A1 where the application A1 does not log on, and forwards the follow/un-follow request to the association unit C2 where the application A1 logs in.

The synchronous follow management unit A3 of the smart terminal A notifies the application client A1 and the application client A2 which log on to the user ID of changing follow states based on the information as to change in follow state upon receiving the information as to change in follow state transmitted by the follow center C. The application client A1 and the application client A2 change follow tag lists thereof based on the information as to change in follow state, respectively.

The synchronous follow management unit B3 of the smart terminal B notifies the application client B1 and the application client B2 which log on to the user ID of changing follow states based on the information as to change in follow state upon receiving the information as to change in follow state transmitted by the follow center C. The application client B1 and the application client B2 change follow tag lists thereof based on the information as to change in follow state.

In the embodiment, follow states of different smart terminals and follow states of different applications in the smart terminal may be unified in a real-time manner. The user only needs to send the follow/un-follow request from a client application, follow/un-follow can be realized synchronously in an associated application of a smart terminal related to the client application, thereby simplifying an operation of the user, and improving the user's experience.

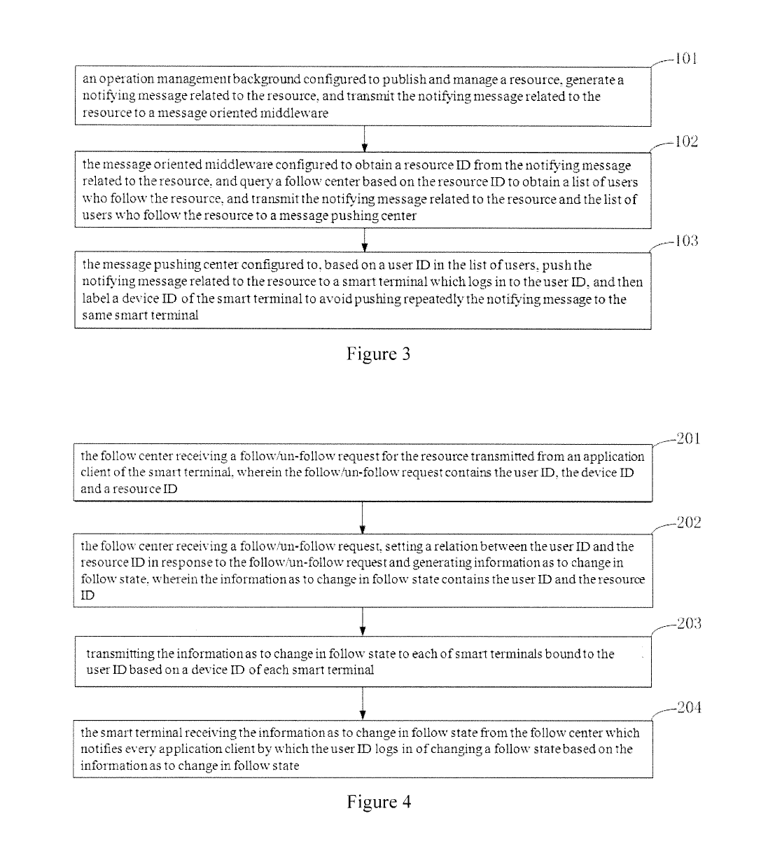

A message pushing method according to an embodiment of the present disclosure is illustrated in FIG. 3. In the embodiment, it is possible to avoid repeatedly transmitting the same notifying message to the same smart terminal. The message pushing method includes:

101, an operation management background publishes and manages a resource, generates a notifying message related to the resource, and transmits the notifying message related to the resource to a message oriented middleware;

102, the message oriented middleware obtains a resource ID from the notifying message related to the resource, and based on the resource ID queries a follow center to obtain a list of users who follow the resource, and transmits the notifying message related to the resource and the list of users who follow the resource to a message pushing center;

103, the message pushing center, based on a user ID in the list of users, pushes the notifying message related to the resource to a smart terminal by which the user ID logs in, and then marks the device ID of the smart terminal to avoid pushing repeatedly the same notifying message to the same smart terminal.

A synchronous follow method according to an embodiment of the present disclosure is illustrated in FIG. 4. In the embodiment, follow states of different smart terminals and follow states of different applications in the smart terminal may be unified in real time. The synchronous follow method may include:

201, an application of a smart terminal transmits a follow/un-follow request for a resource to a follow center, the follow/un-follow request includes a user ID, a device ID and a resource ID.

202, the follow center receives the follow/un-follow request, sets a relation between the device ID and the resource ID in response to the follow/un-follow request, and generates information as to change in follow state including the user ID and the source ID.

203, the follow center transmits the information as to change in follow state to a smart terminal bound to the user ID based on a device ID of the smart terminal.

204, the smart terminal receives the information as to change in follow state transmitted by the follow center, and notifies each of all applications which log on to the user ID of changing an follow state based on the information as to change in follow state.

An embodiment of the present application provides a non-transitory computer-readable storage medium, wherein the said non-transitory computer-readable storage medium stores executable instructions, the said computer can execute the instructions to execute any one of the listed methods.

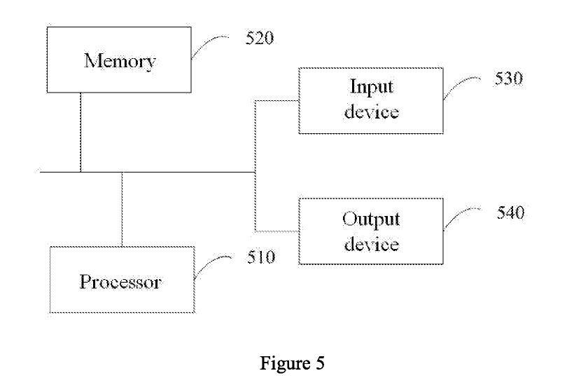

FIG. 5 illustrates the hardware structure of the device executing the message pushing method. Such device comprises:

at least one processor 510 which is shown in FIG. 5 as an example, and a memory 520.

the device executing the message pushing method further comprises: an input device 530 and an output device 540.

processor 510, memory 520, input device 530 and output device 540 can be connected by BUS or other methods, and BUS connecting is showed in FIG. 5 as an example.

Memory 520 can be used for storing non-transitory software program, non-transitory computer executable program and modules as a non-transitory computer-readable storage medium, such as corresponding program instructions/modules for the methods for playing live video mentioned by embodiments of the present disclosure (such as shown in FIG. 1, operation management background D, message orientated middleware E, message pushing center F, follow center C, smart terminal A and smart terminal B). Processor 510 by executing non-transitory software program performs all kinds of functions of a server and process data, instructions and modules which are stored in memory 520, thereby realizes the methods of message pushing mentioned by embodiments of the present disclosure.

Memory 520 can include program storage area and data storage area, thereby the operating system and applications required by at least one function can be stored in program storage area and data created by using the device for playing live video can be stored in data storage area. Furthermore, memory 520 can include high speed Random-access memory (RAM) or non-volatile memory such as magnetic disk storage device, flash memory device or other non-volatile solid state storage devices. In some embodiments, memory 520 can include long-distance setup memories relative to processor 510, which can communicate with the device for pushing messages by networks. The examples of said networks are including but not limited to Internet, Intranet, LAN, mobile Internet and their combinations.

Input device 530 can be used to receive inputted number, character information and key signals causing user configures and function controls of the device. Output device 540 can include a display screen or a display device.

The said module or modules are stored in memory 520 and perform any one of the message pushing methods when executed by one or more processors 510.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions,

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

1-6. (canceled)

7. A message pushing method for an electronic device, comprising:
publishing and managing a resource, and generating a notifying message related to the resource;
obtaining a resource ID from the said notifying message related to the resource, and querying to obtain a list of users who follow the resource based on the resource ID; and
pushing the notifying message related to the resource to a smart terminal by which the user ID is logged in based on the user ID within the said list of users, and then marking the device ID of the smart terminal to avoid pushing repeatedly the same notifying message to the same smart terminal.

8. The message pushing method according to claim 7, further comprising:
receiving a follow/un-follow request for the resource transmitted from an application client of the smart terminal, wherein the follow/un-follow request contains the user ID, the device ID and a resource ID;
setting a relation between the user ID and the resource ID in response to the follow/un-follow request and generating information as to change in follow state, wherein the information as to change in follow state contains the user ID and the resource ID; and
transmitting the information as to change in follow state to each of smart terminals bound to the user ID based on a device ID of each smart terminal.

9. An electronic device, comprising:
at least one processor; and
a memory communicably connected with the at least one processor for storing instructions executable by the at least one processor, wherein execution of the instructions by the at least one processor causes the at least one processor to:
publish and manage a resource, and generate a notifying message related to the resource;
obtain a resource ID from the said notifying message related to the resource, and query to obtain a list of users who follow the resource based on the resource ID
push the notifying message related to the resource to a smart terminal by which the user ID is logged in based on the user ID within the said list of users, and then mark the device ID of the smart terminal to avoid pushing repeatedly the same notifying message to the same smart terminal.

10. The electronic device according to claim 9, wherein the at least one processor is further caused to:
receive a follow/un-follow request for the resource transmitted from an application client of the smart terminal, where the said follow/un-follow request contains a user ID, a device ID and a resource ID;
set a relation between the said user ID and the resource ID in response to the said follow/un-follow request and generating information as to change in follow state, where the information as to change in follow state contains the user ID and the resource ID; and
transmit the information as to change in follow state to each of the smart terminals bound to the user ID based on the device ID of each smart terminal.

11. A non-transitory computer-readable storage medium storing executable instructions that, when executed by an electronic device, cause the electronic device to:
publish and manage a resource, generate a notifying message related to the resource;
obtain a resource ID from the said notifying message related to the resource, and query to obtain a list of users who follow the resource based on the resource ID;
push the notifying message related to the resource to a smart terminal by which the user ID is logged in based on the user ID within the said list of users, and then mark the device ID of the smart terminal to avoid pushing repeatedly the same notifying message to the same smart terminal.

12. A non-transitory computer-readable storage medium according to claim 11, wherein the electronic device is further caused to:
receive a follow/un-follow request for the resource transmitted from an application client of the smart terminal, where the said follow/un-follow request contains a user ID, a device ID and a resource ID;
set a relation between the said user ID and the resource ID in response to the said follow/un-follow request and generating information as to change in follow state, where the information as to change in follow state contains the user ID and the resource ID; and transmit the information as to change in follow state to each of the smart terminals bound to the user ID based on the device ID of each smart terminal.
